(19) United States
(12) Patent Application Publication
(10) Pub. No.: US 2016/0277908 A1
(43) Pub. Date: Sep. 22, 2016

(54) NEWS PUBLISHING SYSTEM AND METHOD

(71) Applicant: NewsByMe, LLC, Fort Myers, FL (US)

(72) Inventors: J. PASON GADDIS, Fort Myers, FL (US); Jeffery Cull, Fort Myers, FL (US)

(21) Appl. No.: 14/660,359

(22) Filed: Mar. 17, 2015

(51) Int. Cl. H04W 4/18; H04W 4/02

(52) U.S. Cl. CPC H04W 4/185; H04W 4/02

(57) ABSTRACT

A method, computer program product, and computing system for generating a geotagged news post, wherein the geotagged new post includes a plurality of discrete geotagged news content items located within a geospecific news region. Feedback concerning one or more of the plurality of discrete geotagged news content items is received from one or more users reviewing the geotagged news post. A ranking score is assigned to each of the plurality of discrete geotagged news content items based, at least in part, upon the feedback received from the one or more users reviewing the geotagged news post. The plurality of discrete geotagged news content items within the geotagged news post is sequenced based, at least in part, upon the ranking score assigned to each of the plurality of discrete geotagged news content items.

### TECHNICAL FIELD

This disclosure relates to publishing systems and, more particularly, to geospecific news publishing systems.

### BACKGROUND

Online news sources allow consumers of the news to obtain news stories and information. Typically, these news sources provide national and/or regional news to the consumer. Unfortunately, these sources tend to be static and provide the same news regardless of the location of the person accessing the source. Accordingly, if you were visiting a specific city, you would typically need to access a source that is local to the city that you are visiting. Further, these news sources tend to be corporate news sources in which the news stories are provided by employees of/contributors to the news source.

### SUMMARY OF DISCLOSURE

In one implementation, a computer-implemented method includes generating a geotagged news post, wherein the geotagged new post includes a plurality of discrete geotagged news content items located within a geospecific news region. Feedback concerning one or more of the plurality of discrete geotagged news content items is received from one or more users reviewing the geotagged news post. A ranking score is assigned to each of the plurality of discrete geotagged news content items based, at least in part, upon the feedback received from the one or more users reviewing the geotagged news post. The plurality of discrete geotagged news content items within the geotagged news post is sequenced based, at least in part, upon the ranking score assigned to each of the plurality of discrete geotagged news content items.

One or more of the following features may be included. The feedback may include an approval indicator concerning one or more of the plurality of discrete geotagged news content items. The geospecific news region may be defined via a point location and a radius. The geospecific news region may be defined based upon GPS coordinates of an electronic device associated with one of the plurality of discrete geotagged news content items. The geospecific news region may be defined based upon cell tower triangulation of an electronic device associated with one of the plurality of discrete geotagged news content items. Additional feedback may be received concerning one or more of the plurality of discrete geotagged news content items. The ranking score assigned to each of the plurality of discrete geotagged news content items may be updated based, at least in part, upon the additional feedback. The plurality of discrete geotagged news content items within the geotagged news post may be resequenced based, at least in part, upon the updated ranking score assigned to each of the plurality of discrete geotagged news content items.

In another implementation, a computing system includes at least one processor and at least one memory architecture coupled with the at least one processor, wherein the computing system is configured to perform operations including generating a geotagged news post, wherein the geotagged new post includes a plurality of discrete geotagged news content items located within a geospecific news region. Feedback concerning one or more of the plurality of discrete geotagged news content items is received from one or more users reviewing the geotagged news post. A ranking score is assigned to each of the plurality of discrete geotagged news content items based, at least in part, upon the feedback received from the one or more users reviewing the geotagged news post. The plurality of discrete geotagged news content items within the geotagged news post is sequenced based, at least in part, upon the ranking score assigned to each of the plurality of discrete geotagged news content items.

One or more of the following features may be included. The feedback may include an approval indicator concerning one or more of the plurality of discrete geotagged news content items. The geospecific news region may be defined via a point location and a radius. The geospecific news region may be defined based upon GPS coordinates of an electronic device associated with one of the plurality of discrete geotagged news content items. The geospecific news region may be defined based upon cell tower triangulation of an electronic device associated with one of the plurality of discrete geotagged news content items. Additional feedback may be received concerning one or more of the plurality of discrete geotagged news content items. The ranking score assigned to each of the plurality of discrete geotagged news content items may be updated based, at least in part, upon the additional feedback. The plurality of discrete geotagged news content items within the geotagged news post may be resequenced based, at least in part, upon the updated ranking score assigned to each of the plurality of discrete geotagged news content items.

In another implementation, a computer program product resides on a computer readable medium that has a plurality of instructions stored on it. When executed by a processor, the instructions cause the processor to perform operations including generating a geotagged news post, wherein the geotagged new post includes a plurality of discrete geotagged news content items located within a geospecific news region. Feedback concerning one or more of the plurality of discrete geotagged news content items is received from one or more users reviewing the geotagged news post. A ranking score is assigned to each of the plurality of discrete geotagged news content items based, at least in part, upon the feedback received from the one or more users reviewing the geotagged news post. The plurality of discrete geotagged news content items within the geotagged news post is sequenced based, at least in part, upon the ranking score assigned to each of the plurality of discrete geotagged news content items.

One or more of the following features may be included. The feedback may include an approval indicator concerning one or more of the plurality of discrete geotagged news content items. The geospecific news region may be defined via a point location and a radius. The geospecific news region may be defined based upon GPS coordinates of an electronic device associated with one of the plurality of discrete geotagged news content items. The geospecific news region may be defined based upon cell tower triangulation of an electronic device associated with one of the plurality of discrete geotagged news content items. Additional feedback may be received concerning one or more of the plurality of discrete geotagged news content items. The ranking score assigned to each of the plurality of discrete geotagged news content items may be updated based, at least in part, upon the additional feedback. The plurality of discrete geotagged news content items within the geotagged news post may be resequenced based, at least in part, upon the updated ranking score assigned to each of the plurality of discrete geotagged news content items.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a news publishing process coupled to a distributed computing network;

FIG. 2 is another diagrammatic view of the news publishing process of FIG. 1;

FIG. 3 is a flow chart of an implementation of the news publishing process of FIG. 1;

FIGS. 4A-4E are diagrammatic views of a user interface rendered by the news publishing process of FIG. 1;

FIG. 5 is a diagrammatic view of a geotagged news post rendered by the news publishing process of FIG. 1;

FIG. 6 is a flow chart of an implementation of the news publishing process of FIG. 1;

FIG. 7 is a flow chart of an implementation of the news publishing process of FIG. 1;

FIG. 8 is a flow chart of an implementation of the news publishing process of FIG. 1;

FIG. 9 is a diagrammatic view of another geotagged news post rendered by the news publishing process of FIG. 1;

FIGS. 10A, 10B and 10D are diagrammatic views of a user interface rendered by the news publishing process of FIG. 1;

FIG. 10C is a diagrammatic view of various news beacons generated by the news publishing process of FIG. 1;

FIG. 11 is a flow chart of an implementation of the news publishing process of FIG. 1; and

FIG. 12 is a flow chart of an implementation of the news publishing process of FIG. 1.

Like reference symbols in the various drawings indicate like elements.

### DETAILED DESCRIPTION OF THE PREFERRED EMBODIMENTS

System Overview:

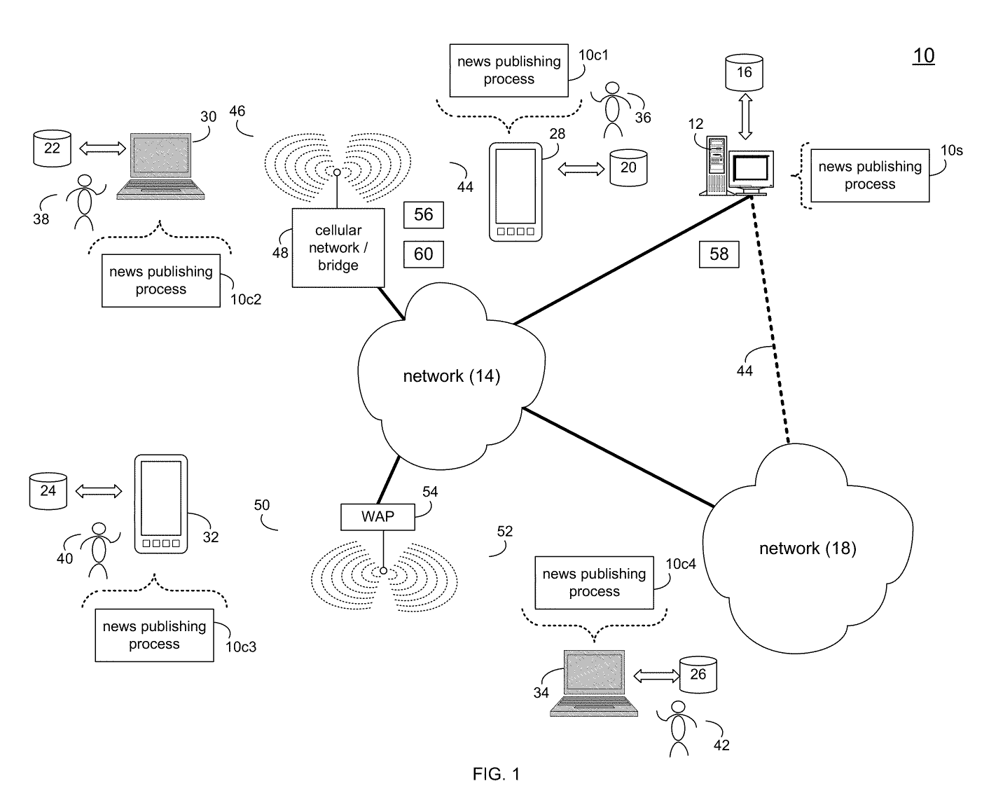

In FIG. 1, there is shown news publishing process 10. As will be discussed below in greater detail, news publishing process 10 may be configured to allow users to publish first-person accounts of new events that they witness and receive notifications of geospecific news events in locations of their choosing.

News publishing process 10 may be implemented as a server-side process, a client-side process, or a hybrid server-side/client-side process. For example, news publishing process 10 may be implemented as a purely server-side process via news publishing process 10s. Alternatively, news publishing process 10 may be implemented as a purely client-side process via one or more of news publishing process 10c1, news publishing process 10c2, news publishing process 10c3, and news publishing process 10c4. Alternatively still, news publishing process 10 may be implemented as a hybrid server-side/client-side process via news publishing process 10s in combination with one or more of news publishing process 10c1, news publishing process 10c2, news publishing process 10c3, and news publishing process 10c4. Accordingly, news publishing process 10, 10s, 10c1, 10c2, 10c3, 10c4 as used in this disclosure may include any combination of news publishing process 10s, news publishing process 10c1, news publishing process 10c2, news publishing process 10c3, and news publishing process 10c4.

News publishing process 10s may be a server application and may reside on and may be executed by computing device 12, which may be connected to network 14 (e.g., the Internet or a local area network). Examples of computing device 12 may include, but are not limited to: a personal computer, a laptop computer, a tablet computer, a personal digital assistant, a data-enabled cellular telephone, a notebook computer, a television with one or more processors embedded therein or coupled thereto, a server computer, a series of server computers, a mini computer, a mainframe computer, or a dedicated network device.

The instruction sets and subroutines of news publishing process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of news publishing processes 10c1, 10c2, 10c3, 10c4 may include but are not limited to a web browser, a game console user interface, a social network user interface, or a specialized application. The instruction sets and subroutines of news publishing processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, data-enabled, cellular telephone 28, laptop computer 30, personal digital assistant 32, notebook computer 34, a tablet computer (not shown), a personal computer (not shown), a server computer (not shown), a smart television (not shown), a gaming console (not shown), and a dedicated network device (not shown). Client electronic devices 28, 30, 32, 34 may each execute an operating system.

Users 36, 38, 40, 42 may access news publishing process 10 directly through network 14 or through secondary network 18. Further, news publishing process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 44, 46 (respectively) established between data-enabled, cellular telephone 28, laptop computer 30 (respectively) and cellular network/bridge 48, which is shown directly coupled to network 14. Further, personal digital assistant 32 and notebook computer 34 are shown wirelessly coupled to network 14 via wireless communication channels 50, 52 (respectively) established between personal digital assistant 32, notebook computer 34 (respectively) and wireless access point (i.e., WAP) 54, which is shown directly coupled to network 14.

WAP 54 may be, for example, an IEEE 802.11a, 802.11b, 802.11g, 802.11n, Wi-Fi, and/or Bluetooth device that is capable of establishing wireless communication channels 50, 52 (respectively) between personal digital assistant 32, notebook computer 34 (respectively) and wireless access point (i.e., WAP) 54. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### News Publishing Process:

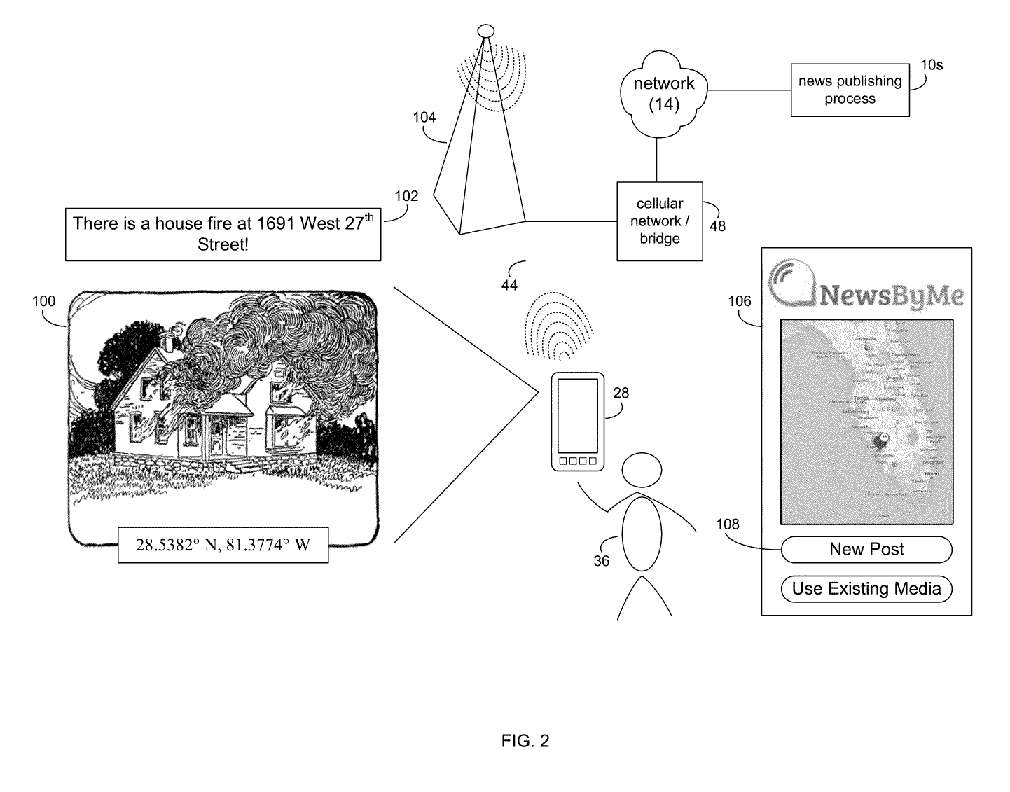

As discussed above, news publishing process 10 may be configured to allow users to publish first-person accounts of new events that they witness. Assume for illustrative purposes that user 36 is walking down a road in Orlando, Fla. and witnesses a house fire in progress (that has already been reported using the 911 system). Accordingly and referring also to FIG. 2, user 36 may utilize data-enabled, cellular telephone 28 to take a picture (e.g., picture 100) of the news event unfolding in front of them (i.e., the house fire). User 36 may also add a text description (e.g., description 102) of the news event, such as “There is a house fire at 1691 West 27th Street!”. This information (e.g., picture 100 and description 102) may then be provided to news publishing process 10 by way of wireless communication channel 44 that is established between data-enabled, cellular telephone 28 and cellular network/bridge 48 (via cell tower 104).

Specifically, assume that when user 36 notices the above-mentioned house fire, they launch the client side version of news publishing process 10 (namely and in this example, news publishing process 10c1). This may result in the rendering of user interface 106 on data-enabled, cellular telephone 28. For this example, assume that user 36 selects “new post” button 108 by e.g., tapping on “new post” button 108 using a finger (i.e., if the display of data-enabled, cellular telephone 28 is a touch screen).

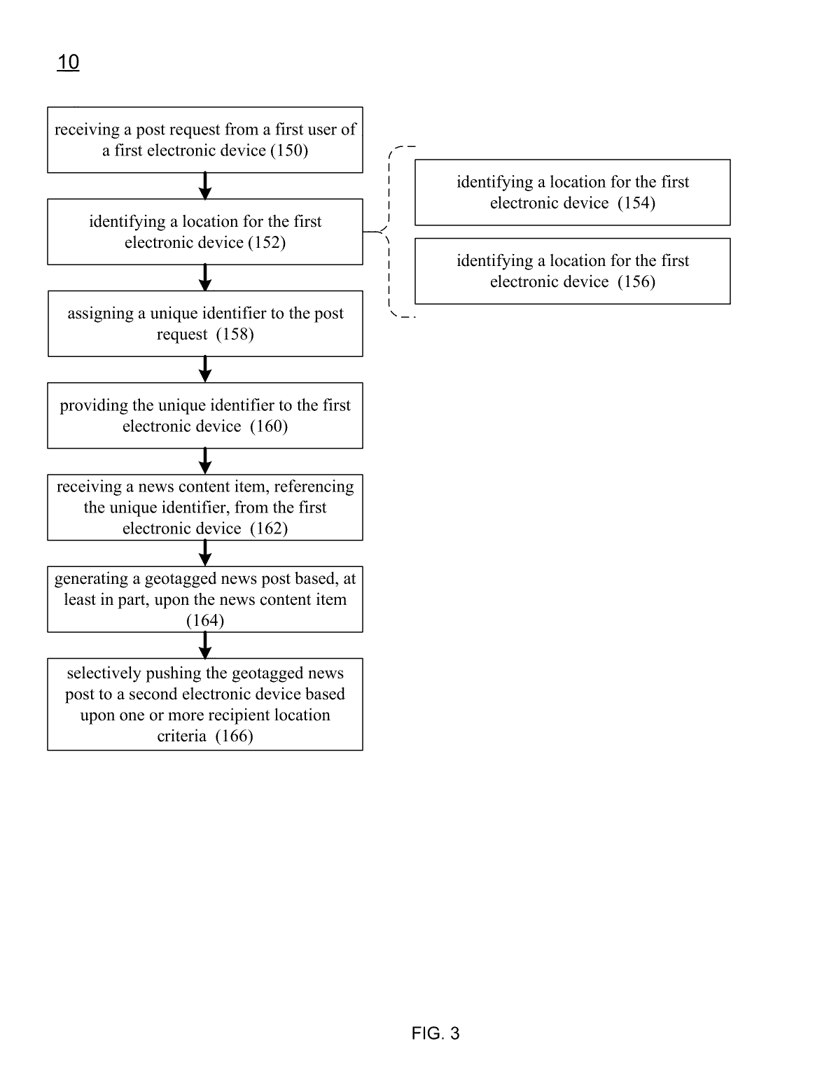

Referring also to FIG. 3, upon user 36 selecting “new post” button 108, a post request (e.g., post request 56) may be generated (e.g., by news publishing process 10c1). Post request 56 may be provided to news publishing process 10s. News publishing process 10s may receive 150 post request 56 from user 36 of data-enabled, cellular telephone 28.

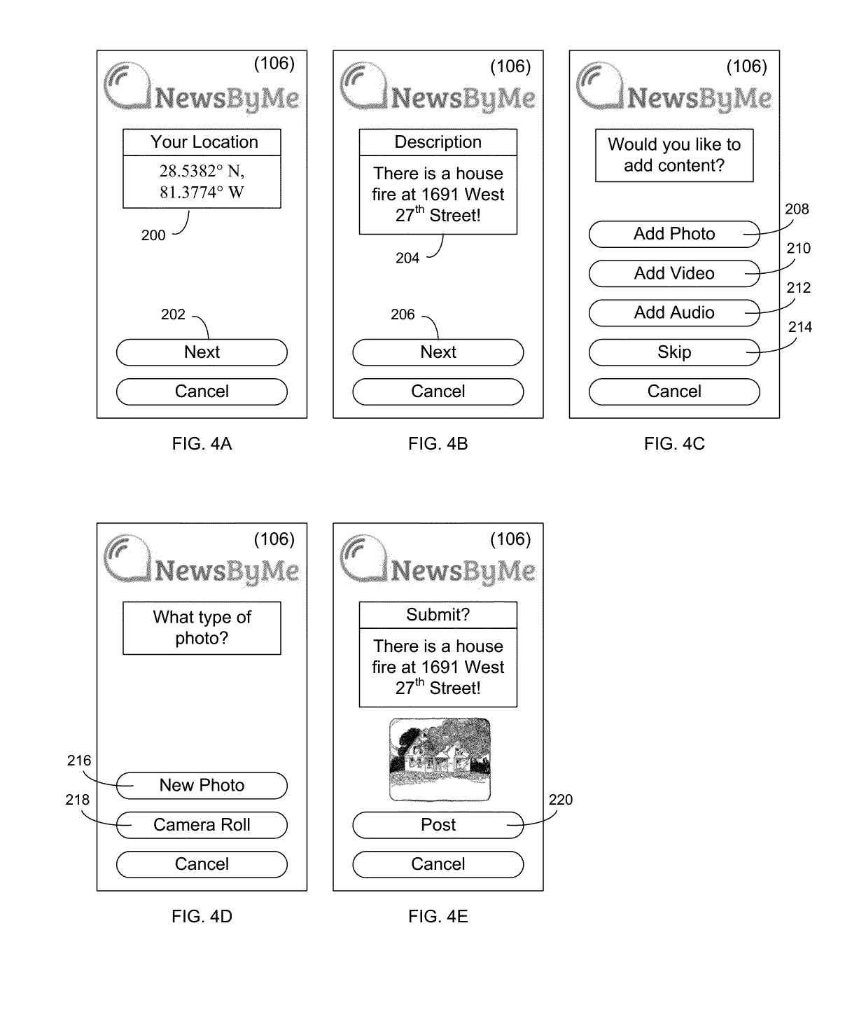

Upon receiving 150 post request 56, news publishing process 10 may identify 152 a location for data-enabled, cellular telephone 28, thus defining a first identified location (e.g., 28.5382° N, 81.3774° W). When identifying 152 a location of e.g., data-enabled, cellular telephone 28, news publishing process 10 may identify 154 the location of data-enabled, cellular telephone 28 via GPS coordinates (obtained from GPS circuitry included within data-enabled, cellular telephone 28). Alternatively, when identifying 152 a location for e.g., data-enabled, cellular telephone 28, news publishing process 10 may identify 156 the location of data-enabled, cellular telephone 28 via cell tower triangulation. Accordingly, when post request 56 is initially generated (e.g., by news publishing process 10c1), news publishing process 10c1 may query the above-described GPS circuitry included within data-enabled, cellular telephone 28 or may perform the above-described cell tower triangulation procedure; and may include within post request 56 this location information (e.g., location information 200, as shown in FIG. 4A).

News publishing process 10s may assign 158 a unique identifier (e.g., unique identifier 58) to post request 56. News publishing process 10s may then provide 160 unique identifier 58 to data-enabled, cellular telephone 28. Unique identifier 58 may be utilized by new publishing process 10 to uniquely identify all information related to post request 56.

Upon receiving unique identifier 58, user 36 may select “Next” button 202 and begin to generate content for the news event unfolding in front of them (i.e., the house fire). Accordingly, news publishing process 10c1 (in combination with user interface 106 rendered on data-enabled, cellular telephone 28) may allow user 36 to enter a text description of the news event (i.e., the house fire). For example, user 36 may enter the text “There is a house fire at 1691 West 27th Street!” within description field 204 (as shown in FIG. 4B) and may then select “Next” button 206. This content (e.g., the text description) may then be provided to news publishing process 10s referencing unique identifier 58.

Additionally, news publishing process 10c1 (in combination with user interface 106 rendered on data-enabled, cellular telephone 28) may allow user 36 to add additional content (e.g., photographic content via “Add Photo” button 208, FIG. 4C; video content via “Add Video” button 210; or audio content via “Add Audio” button 212) for the news event (i.e., the house fire). Alternatively, user 36 may choose to not add additional content (by selecting “Skip” button 214).

For this example, assume that user 36 wants to add a photograph that they took at the scene. Accordingly, user 36 may select “Add Photo” button 208, resulting in user interface 106 inquiring (as shown in FIG. 4D) whether user 36 would like to take a new photo (for which user 36 would select “New Photo” button 216) or use an existing photo (for which user 36 would select “Camera Roll” button 218.

Assume for this example that user 36 wants to add a new photograph (e.g., photograph 100). Accordingly, user 36 may select “New Photo” button 216, resulting in the launching of the camera application (not shown) on data-enabled, cellular telephone 28. Once the photograph (e.g., photograph 100) is taken, this content (e.g., photograph 100) may then be provided to news publishing process 10s referencing unique identifier 58.

In the event that user 36 chose to use an existing photo (for which user 36 would select “Camera Roll” button 218), news publishing process 10 may obtain the above-described location information from geotagging metadata associated with the existing photo that user 36 chose. Therefore, in the event that user 36 takes a photo while e.g., on a moving train, the location of the news event may be accurately determined by examining the existing photo.

Additionally, news publishing process 10c1 (in combination with user interface 106 rendered on data-enabled, cellular telephone 28) may allow user 36 to confirm (as shown in FIG. 4E) the content of the post to be made (i.e., confirm the text description entered and the photograph selected) and then user 36 may select “Post” button 22, thus submitting this news content item (in this example, including a text description, a photograph and a location) to news publishing process 10 for publication.

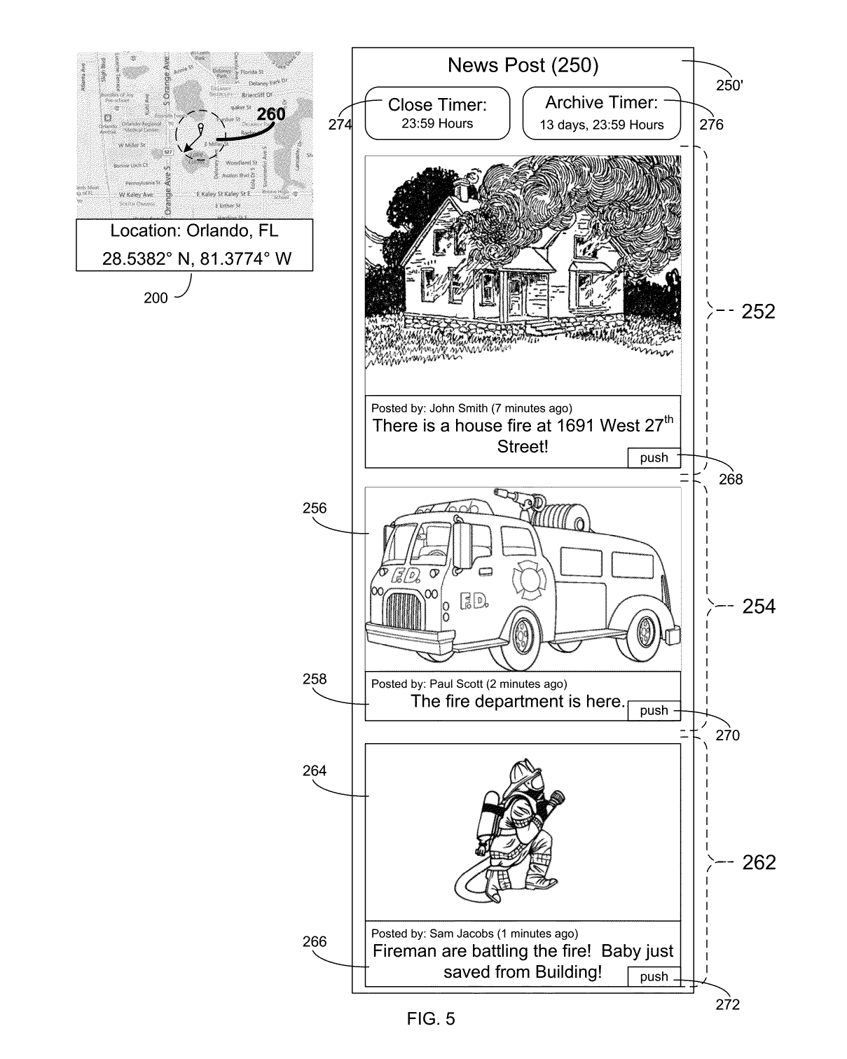

Referring also to FIG. 5, once news publishing process 10 receives 162 the news content item (e.g., the above-described text description, photograph and location), which references unique identifier 58, from (in this example) data-enabled, cellular telephone 28, news publishing process 10 may generate 164 geotagged news post 250 based, at least in part, upon the above-described news content item (e.g., news content item 252), wherein geotagged news post 250 is geotagged with the first identified location (e.g., location information 200).

As will be discussed below in greater detail, news publishing process 10 may selectively push 166 geotagged news post 250 to other client electronic devices (e.g., laptop computer 30, personal digital assistant 32, notebook computer 34, a tablet computer (not shown), a personal computer (not shown), a server computer (not shown), a smart television (not shown), a gaming console (not shown), and a dedicated network device (not shown)) based upon one or more recipient location criteria.

An example of such recipient location criteria may include but is not limited to the current location of the other electronic devices, thus enabling users of the other electronic devices to receive news content that is proximate their current location. Additionally/alternatively, such recipient location criteria may include but is not limited to a predefined geospecific news beacon associated with the other electronic devices, thus enabling users of the other electronic devices to receive news content that is proximate a location that they are interested in (e.g., their hometown, a favorite vacation spot, a political nerve center, etc.).

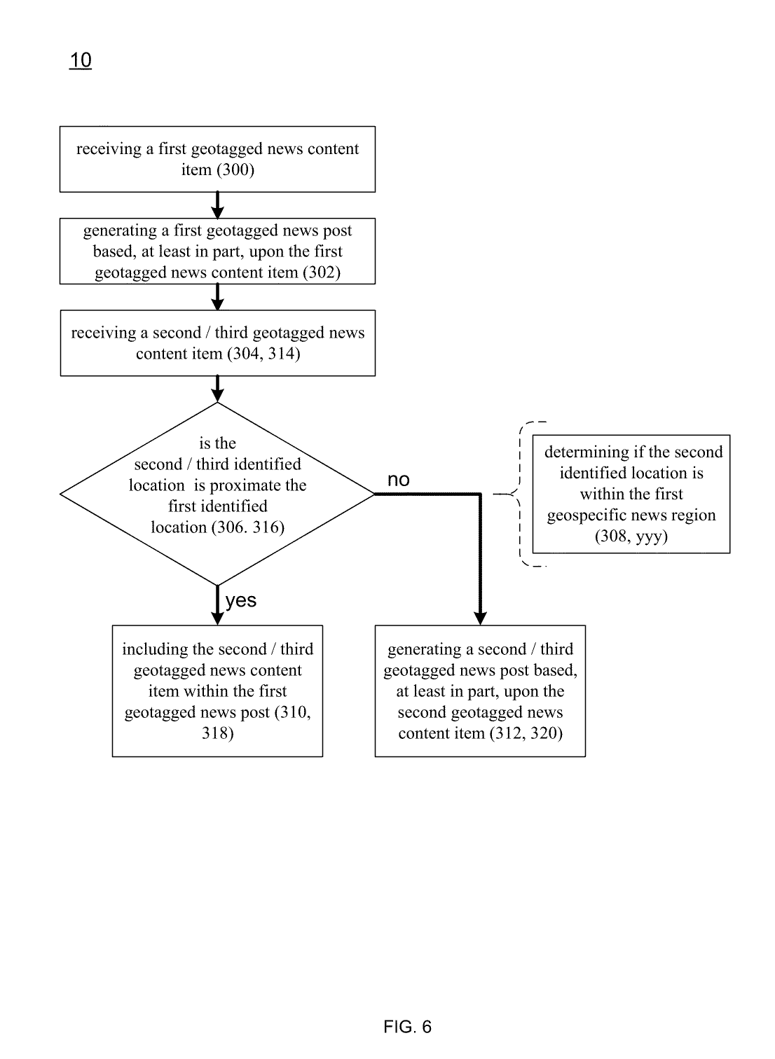

New publishing process 10 may be configured to allow multiple users to supplement and contribute to (in this example) geotagged news post 250. For example and referring also to FIG. 6, news publishing process 10 may receive 300 a first geotagged news content item (e.g., news content item 252), wherein the first geotagged news content item (e.g., news content item 252) is based, at least in part, upon first news content (e.g., picture 100 and description 102) associated with a first identified location (e.g., location information 200). As discussed above, news publishing process 10 may generate 302 a first geotagged news post (e.g., geotagged news post 250) based, at least in part, upon the first geotagged news content item (e.g., news content item 252).

News publishing process 10 may receive 304 a second geotagged news content item (e.g., news content item 254), wherein the second geotagged news content (e.g., news content item 254) is based, at least in part, upon second news content (e.g., picture 256 and description 258) associated with a second identified location (defined via e.g., GPS coordinates or cell tower triangulation). Assume for illustrative purposes that the second geotagged news content item (e.g., news content item 254) is received 304 from user 38 via laptop computer 30. News publishing process 10 may determine 306 if the second identified location (e.g., the location of laptop computer 30 and, therefore, user 38) is proximate the first identified location (e.g., location information 200).

The first identified location (e.g., location information 200) may define a first geospecific news region (e.g., geospecific news region 260). The first geospecific news region (e.g., geospecific news region 260) may be defined via a point location (e.g., 28.5382° N, 81.3774° W) and a radius (e.g., 500 feet). Accordingly and when determining 306 if the second identified location (e.g., the location of laptop computer 30 and, therefore, user 38) is proximate the first identified location (e.g., location information 200), news publishing process 10 may determine 308 if the second identified location (e.g., the location of laptop computer 30 and, therefore, user 38) is within the first geospecific news region (e.g., geospecific news region 260).

If the second identified location (e.g., the location of laptop computer 30 and, therefore, user 38) is proximate the first identified location (e.g., location information 200), news publishing process 10 may include 310 the second geotagged news content item (e.g., news content item 254) within the first geotagged news post (e.g., geotagged news post 250). Conversely, if the second identified location (e.g., the location of laptop computer 30 and, therefore, user 38) is not proximate the first identified location (e.g., location information 200), news publishing process 10 may generate 312 a second geotagged news post (not shown) based, at least in part, upon the second geotagged news content item (e.g., news content item 254). If news publishing process 10 generates 312 the above-described second geotagged news post (not shown), this second geotagged news post (not shown) may be separate and distinct from geotagged news post 250.

This above-described process of receiving geotagged news content items and determining whether they are proximate the first identified location (e.g., location information 200) may continue as additional geotagged news content items are received by news publishing process 10. For example, news publishing process 10 may receive 314 a third geotagged news content item (e.g., news content item 262), wherein the third geotagged news content item (e.g., news content item 262) is based, at least in part, upon third news content (e.g., picture 264 and description 266) associated with a third identified location (defined via e.g., GPS coordinates or cell tower triangulation). Assume for illustrative purposes that the third geotagged news content item (e.g., news content item 262) is received 314 from user 40 via personal digital assistant 32.

News publishing process 10 may determine 316 if the third identified location is proximate the first identified location (e.g., location information 200). If the third identified location (e.g., the location of personal digital assistant 32 and, therefore, user 40) is proximate the first identified location (e.g., location information 200), news publishing process 10 may include 318 the third geotagged news content item (e.g., news content item 262) within the first geotagged news post (e.g., geotagged news post 250). If the third identified location is not proximate the first identified location (e.g., location information 200), news publishing process 10 may generate 320 a third geotagged news post (not shown) based, at least in part, upon the third geotagged news content item (e.g., news content item 262). If news publishing process 10 generates 320 the above-described third geotagged news post (not shown), this third geotagged news post (not shown) may be separate and distinct from geotagged news post 250.

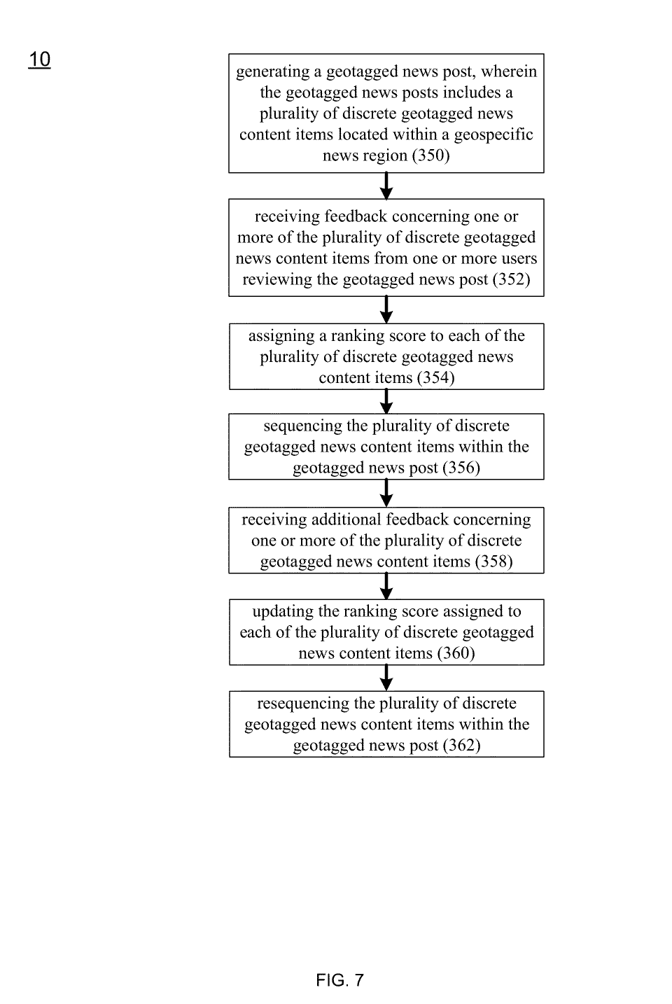

New publishing process 10 may be configured to allow users to rate/rank the news content items (e.g., news content items 252, 254, 262) that are included within a geotagged news post (e.g., geotagged news post 250). For example and referring also to FIG. 7, news publishing process 10 may generate 350 a geotagged news post (e.g., geotagged news post 250), wherein geotagged news post (e.g., geotagged news post 250) includes a plurality of discrete geotagged news content items (e.g., news content items 252, 254, 262) located within a geospecific news region (e.g., geospecific news region 260). As discussed above, this first geospecific news region (e.g., geospecific news region 260) may be defined via a point location (e.g., 28.5382° N, 81.3774° W) and a radius (e.g., 500 feet), wherein the point location may be defined via the above-described GPS circuitry or via the above-described cell tower triangulation procedure

News publishing process 10 may receive 352 feedback concerning one or more of the plurality of discrete geotagged news content items (e.g., news content items 252, 254, 262) from one or more users (e.g., users 36, 38, 40, 42) reviewing the geotagged news post (e.g., geotagged news post 250) and may assign 354 a ranking score to each of the plurality of discrete geotagged news content items (e.g., news content items 252, 254, 262) based, at least in part, upon the feedback received from the one or more users (e.g., users 36, 38, 40, 42) reviewing the geotagged news post (e.g., geotagged news post 250). Examples of such feedback may include an approval indicator concerning one or more of the plurality of discrete geotagged news content items (e.g., news content items 252, 254, 262).

News publishing process 10 may then sequence 356 the plurality of discrete geotagged news content items (e.g., news content items 252, 254, 262) within the geotagged news post (e.g., geotagged news post 250) based, at least in part, upon the ranking score assigned to each of the plurality of discrete geotagged news content items (e.g., news content items 252, 254, 262).

Geotagged news post 250 is shown to include (for illustrative purposes) three geotagged news content items (e.g., news content items 252, 254, 262). Each of the three geotagged news content items (e.g., news content items 252, 254, 262) is shown to include (in this example) a “Push” button (e.g., “Push” buttons 268, 270, 272, respectively). “Push” buttons 268, 270, 272 may be configured to allow the users (e.g., users 36, 38, 40, 42) of news publishing system to provide feedback and show approval for particular content item(s) by “voting” for the news content item(s) that they like within geotagged news post 250. These votes (e.g., “pushes”) for each of the geotagged news content items (e.g., news content items 252, 254, 262) may be totaled to generate the above-referenced “ranking score” for each news content item.

For example, if users 36, 38, 40 like (e.g., “push”) news content item 262, news publishing process 10 may receive 352 three “votes” concerning news content item 262 and news content item 262 may be assigned 354 a ranking score of “3”. Further, if users 40, 42 like (e.g., “push”) news content item 252, news publishing process 10 may receive 352 two “votes” concerning news content item 252 and news content item 252 may be assigned 354 a ranking score of “2”. Additionally, if user 38 likes (e.g., “pushes”) news content item 254, news publishing process 10 may receive 352 one “vote” concerning news content item 254 and news content item 254 may be assigned 354 a ranking score of “1”.

As discussed above, news publishing process 10 may then sequence 356 the plurality of discrete geotagged news content items (e.g., news content items 252, 254, 262) within the geotagged news post (e.g., geotagged news post 250) based, at least in part, upon the ranking score assigned to each of the plurality of discrete geotagged news content items (e.g., news content items 252, 254, 262). Since news content item 262 was assigned 354 a ranking score of “3”, news content item 252 was assigned 354 a ranking score of “2”, and news content item 254 was assigned 354 a ranking score of “1”; news publishing process 10 may sequence 356 news content items 252, 254, 262 so that news content items 262 is positioned in first place, news content items 252 is positioned in second place, and news content items 254 is positioned in third place. Accordingly, news publishing process 10 may sequence 356 news content items 252, 254, 262 so that they are no longer in their original order (namely the order in which they were originally generated, oldest first/newest last) but now reflect their popularity, as voted by the users of news publishing process 10.

News publishing process 10 may receive 358 additional feedback concerning one or more of the plurality of discrete geotagged news content items (e.g., news content items 252, 254, 262). News publishing process 10 may update 360 the ranking score assigned to each of the plurality of discrete geotagged news content items (e.g., news content items 252, 254, 262) based, at least in part, upon the additional feedback. News publishing process 10 may then resequence 362 the plurality of discrete geotagged news content items (e.g., news content items 252, 254, 262) within the geotagged news post (e.g., geotagged news post 250) based, at least in part, upon the updated ranking score assigned to each of the plurality of discrete geotagged news content items (e.g., news content items 252, 254, 262).

For example, if one additional user likes (e.g., “pushes”) news content item 262, news publishing process 10 may receive 358 one additional “vote” concerning news content item 262 and news publishing process 10 may update 360 the ranking score of news content item 262 to “4” (i.e., 3+1). Further, if five additional users like (e.g., “push”) news content item 252, news publishing process 10 may receive 358 five additional “votes” concerning news content item 252 and news publishing process 10 may update 360 the ranking score of news content item 252 to “7” (i.e., 2+5). Additionally, if one additional user likes (e.g., “pushes”) news content item 254, news publishing process 10 may receive 352 one additional “vote” concerning news content item 254 and news publishing process 10 may update 360 the ranking score of news content item 254 to “2” (i.e., 1+1).

Since news content item 262 was updated 360 to a ranking score of “4”, news content item 252 was updated 360 to a ranking score of “7”, and news content item 254 was updated 360 to a ranking score of “2”; news publishing process 10 may resequence 362 news content items 252, 254, 262 so that news content items 252 is positioned in first place, news content items 262 is positioned in second place, and news content items 254 is positioned in third place.

As discussed above, news publishing process 10 may be configured to allow users to publish first-person accounts of new events that they witness and receive notifications of geospecific news events in locations of their choosing. In order to keep the news events being reported to the users of news publishing process 10 fresh and current, timers may be utilized to e.g., close news posts and archive news posts after the expiry of such timers.

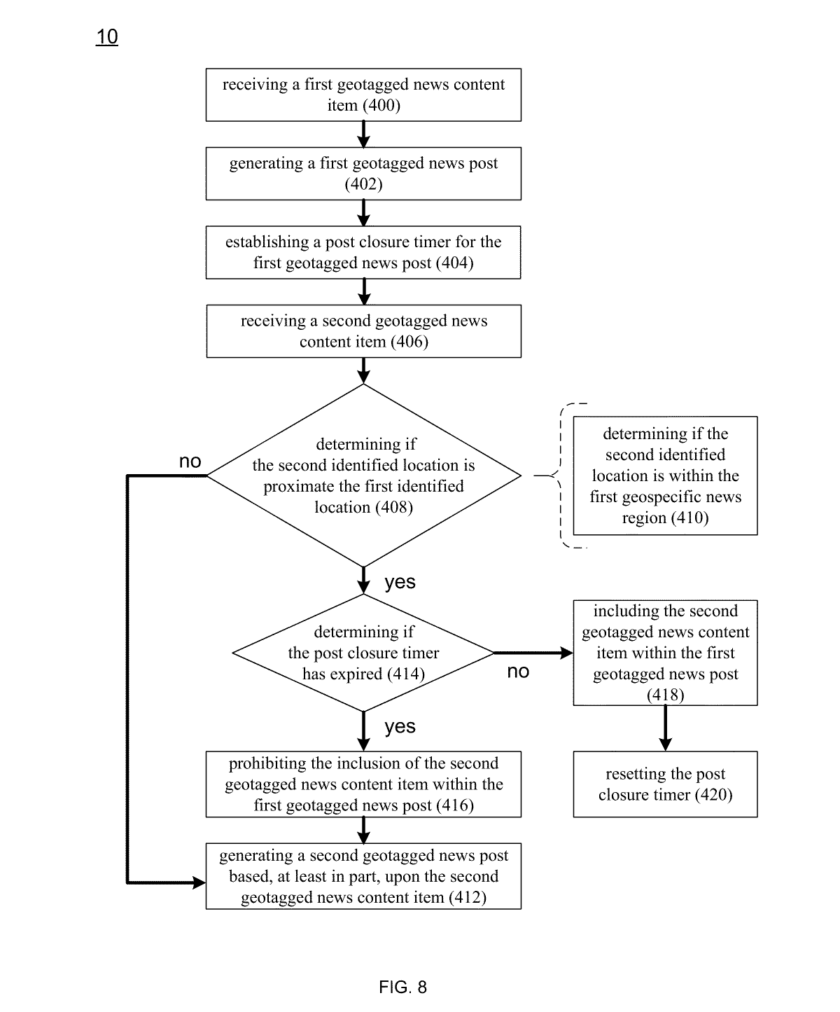

Specifically and referring also to FIG. 8, news publishing process 10 may receive 400 a first geotagged news content item items (e.g., news content item 252), wherein the first geotagged news content item (e.g., news content item 252) is based, at least in part, upon first news content (e.g., picture 100 and description 102) associated with a first identified location (e.g., location information 200). News publishing process 10 may generate 402 a first geotagged news post (e.g., geotagged news post 250) based, at least in part, upon the first geotagged news content item (e.g., news content item 252). Additionally, news publishing process 10 may establish 404 one or more post closure timers (e.g., timers 274, 276) for the first geotagged news post (e.g., geotagged news post 250), wherein a closure event may occur concerning first geotagged news post (e.g., geotagged news post 250) upon the expiry of the post closure timer (e.g., timers 274, 276). Examples of the closure event that may occur at the expiry of the post closure timer (e.g., timers 274, 276) may include but are not limited to a) archiving the first geotagged news post, and b) closing the news post to prohibit the inclusion of additional geotagged news content items within the first geotagged news post.

For example, geotagged news post 250 is shown to include two post closure timers, namely post closure timer 274 (upon the expiry of which geotagged news post 250 may be closed and users of news publishing process 10 may be prohibited from adding any new geotagged news content items) and post closure timer 276 (upon the expiry of which geotagged news post 250 may be archived and no longer available to the users of news publishing process 10).

Assume for illustrative purposes that, upon the generation 402 of geotagged news post 250, news publishing process 10 may establish 404 post closure timer 274 with an initial value of e.g., 24 hours and post closure timer 276 within an initial value of 14 days, wherein these values will decrement (until their expiry) with the passage of time. These values are for illustrative purposes only and are not intended to be a limitation of this disclosure, as other configurations are possible. For example and as will be discussed below in greater detail, these values may be dynamically adjusted to maintain a desired level of content within news publishing process 10.

As discussed above, the closure event may include archiving the first geotagged news post (e.g., geotagged news post 250), thus generating archived first geotagged news post (e.g., archived geotagged news post 250′). In the event that first geotagged news post (e.g., geotagged news post 250) is archived (thus generating archived geotagged news post 250′), geotagged news post 250 may no longer be viewable to the users (e.g., users 36, 38, 40, 42). News publishing process 10 may or may not be configured to allow the users (e.g., users 36, 38, 40, 42) to search geotagged news posts that have been archived (e.g., archived geotagged news post 250′).

Further and as discussed above, the closure event may include closing the news post and prohibiting the inclusion of additional geotagged news content items within the first geotagged news post (e.g., geotagged news post 250). Accordingly and when such an event occurs, geotagged news post 250 would be closed (e.g., users will not be able to add additional geotagged news content items to geotagged news post 250). However, geotagged news post 250 may not be archived until the expiry of post closure timer 276.

Assume for illustrative purposes that news publishing process 10 receives 406 a second geotagged news content item (e.g., news content item 254), wherein the second geotagged news content item (e.g., news content item 254) is based, at least in part, upon second news content associated (e.g., picture 256 and description 258) associated with a second identified location (e.g., the location of laptop computer 30 and, therefore, user 38).

Upon receiving 406 news content item 254, news publishing process 10 may determine 408 if the second identified location (e.g., the location of laptop computer 30 and, therefore, user 38) is proximate the first identified location (e.g., location information 200). As discussed above, the first identified location (e.g., location information 200) may define a first geospecific news region (e.g., geospecific news region 260), wherein geospecific news region 260 may be defined via a point location (e.g., 28.5382° N, 81.3774° W) and a radius (e.g., 500 feet).

Accordingly and when determining 408 if the second identified location (e.g., the location of laptop computer 30 and, therefore, user 38) is proximate the first identified location (e.g., location information 200), news publishing process 10 may determine 410 if the second identified location (e.g., the location of laptop computer 30 and, therefore, user 38) is within the first geospecific news region (e.g., geospecific news region 260).

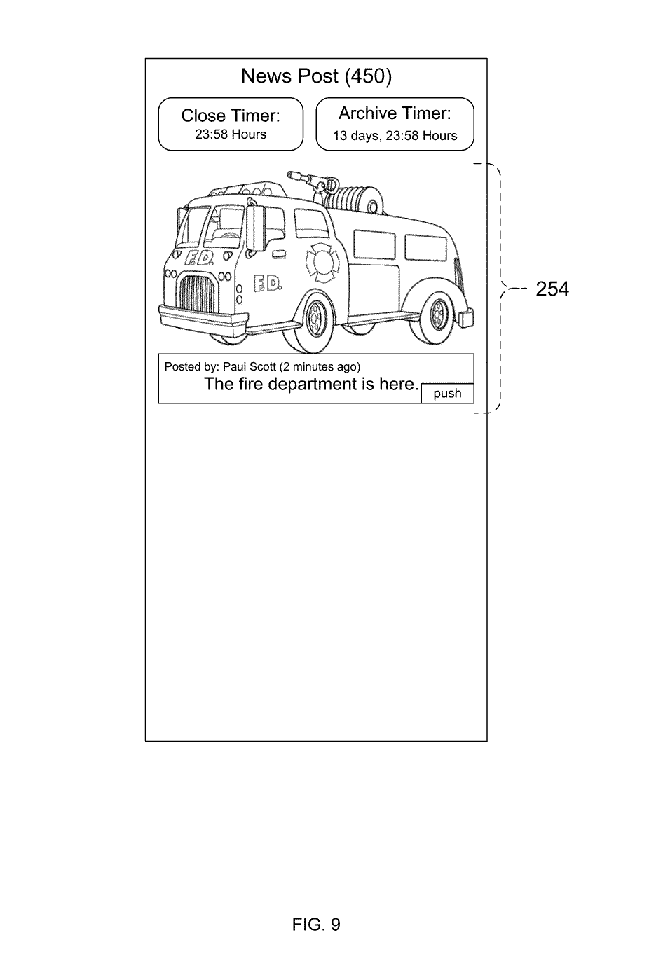

If the second identified location (e.g., the location of laptop computer 30 and, therefore, user 38) is not proximate the first identified location (e.g., location information 200), new publishing process 10 may generate 412 a second geotagged news post (e.g., second geotagged news post 450 as shown in FIG. 9) based, at least in part, upon the second geotagged news content item (e.g., news content item 254), wherein second geotagged news post 450 may be a separate and distinct news post with respect to geotagged news post 250.

If the second identified location (e.g., the location of laptop computer 30 and, therefore, user 38) is proximate the first identified location (e.g., location information 200), news publishing process 10 may determine 414 if the above-described post closure timer(s) expired.

If the post closure timer has expired, news publishing process 10 may prohibit 416 the inclusion of the second geotagged news content item (e.g., news content item 254) within the first geotagged news post (e.g., geotagged news post 250) and may generate 412 a second geotagged news post (e.g., second geotagged news post 450 as shown in FIG. 9) based, at least in part, upon the second geotagged news content item (e.g., news content item 254), wherein second geotagged news post 450 may be a separate and distinct news post with respect to geotagged news post 250.

If the post closure timer (e.g., post closure timer 274 and/or post closure timer 276) has not expired, news publishing process 10 may include 418 the second geotagged news content item (e.g., news content item 254) within the first geotagged news post (e.g., geotagged news post 250), as previously shown in FIG. 5.

As discussed above, the closure event may include archiving the first geotagged news post (e.g., geotagged news post 250) or prohibiting the inclusion of additional geotagged news content items within the first geotagged news post (e.g., geotagged news post 250). Further and as discussed above, a first post closure timer (e.g., post closure timer 274) may be established to define when the first geotagged news post (e.g., geotagged news post 250) is closed (i.e., no longer accepting new geotagged news content items) and a second post closure timer (e.g., post closure timer 276) may be established to define when the first geotagged news post (e.g., geotagged news post 250) is archived (i.e., no longer available). These timers (e.g., post closure timers 274, 276) may be static or dynamic in nature. For example, one or both of post closure timers 274, 276 may be static and set upon the generation of geotagged news post 250 and never reset/adjusted. Alternatively, one or both of post closure timers 274, 276 may be dynamic and set upon the generation of geotagged news post 250 and reset/adjusted each time that e.g., an additional geotagged news content item is added to geotagged news post 250.

Accordingly and in the event that news publishing process 10 includes 418 news content item 254 within geotagged news post 250, news publishing process 10 may reset 420 the post closure timer to e.g., extend the amount of time for which additional geotagged news content items may be added to geotagged news post 250 and/or extend the amount of time until geotagged news post 250 is archived.

As stated above, news publishing process 10 may selectively push geotagged news post 250 to other client electronic devices (e.g., laptop computer 30, personal digital assistant 32, notebook computer 34, a tablet computer (not shown), a personal computer (not shown), a server computer (not shown), a smart television (not shown), a gaming console (not shown), and a dedicated network device (not shown)) based upon one or more recipient location criteria, wherein examples of such recipient location criteria may include but is not limited to the current location of the other electronic devices (thus enabling users of the other electronic devices to receive news content that is proximate their current location) and/or a predefined geospecific news beacon associated with the other electronic devices (thus enabling users of the other electronic devices to receive news content that is proximate a location that they are interested in).

For example, assume that user 42 was born in Des Moines, Iowa, went to college in San Francisco, Calif., and lives in Tampa Bay, Fla. Therefore, user 42 may be interested in news stories from all three of those areas. Accordingly, news publishing process 10 may be configurable by user 42 to identify these locations and have news posts from these areas pushed to (in this example) notebook computer 34.

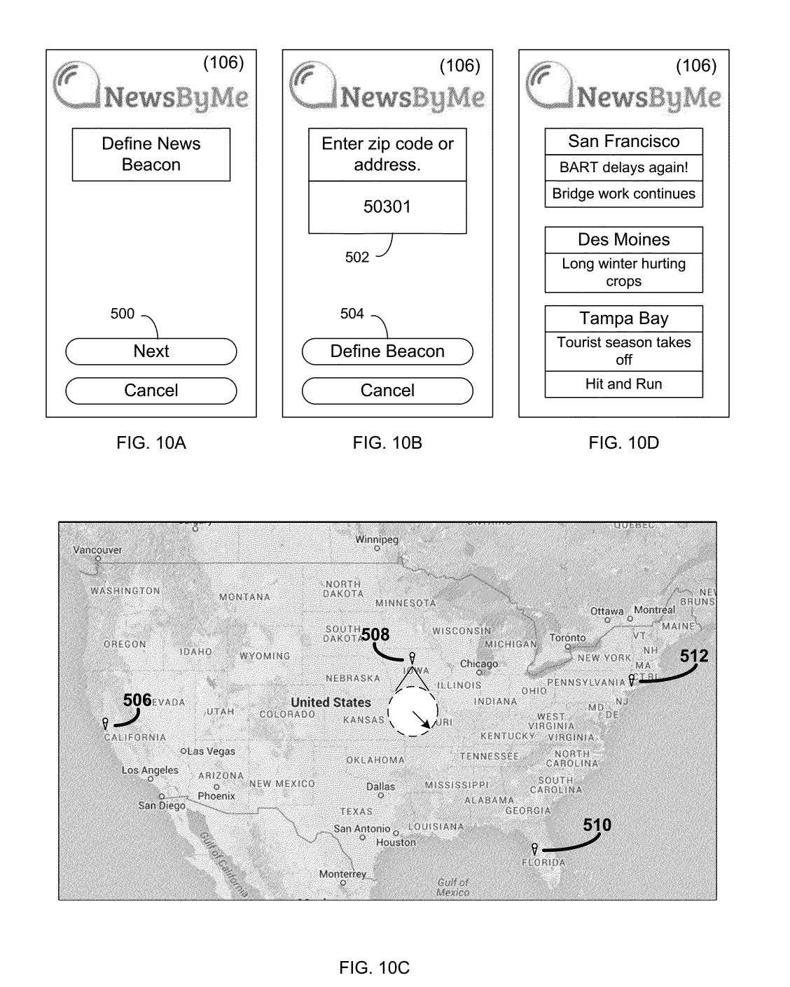

Accordingly and referring also to FIGS. 10A-10C, user 42 may utilize user interface 106 to define news beacons for each of these three areas of interest. For example, user interface 106 may allow user 42 to initiate the process of defining a news beacon (as shown in FIG. 10A), wherein user 42 may select “Next” button 500 within user interface 106. News publishing process 10 may then allow user 42 to define a news beacon by way of e.g., entering a zip code, address for the area of interest, or entering “current location”. In this example, user 52 may enter a zip code for Des Moines, Iowa (e.g., 50301). Once entered, user 42 may select “Define Beacon” button 504, thus providing the appropriate request (e.g., request 60) to news publishing process 10s. This process may be repeated for each of (in this example) the three areas of interest (as shown in FIG. 10C) and/or the “current location” news beacon.

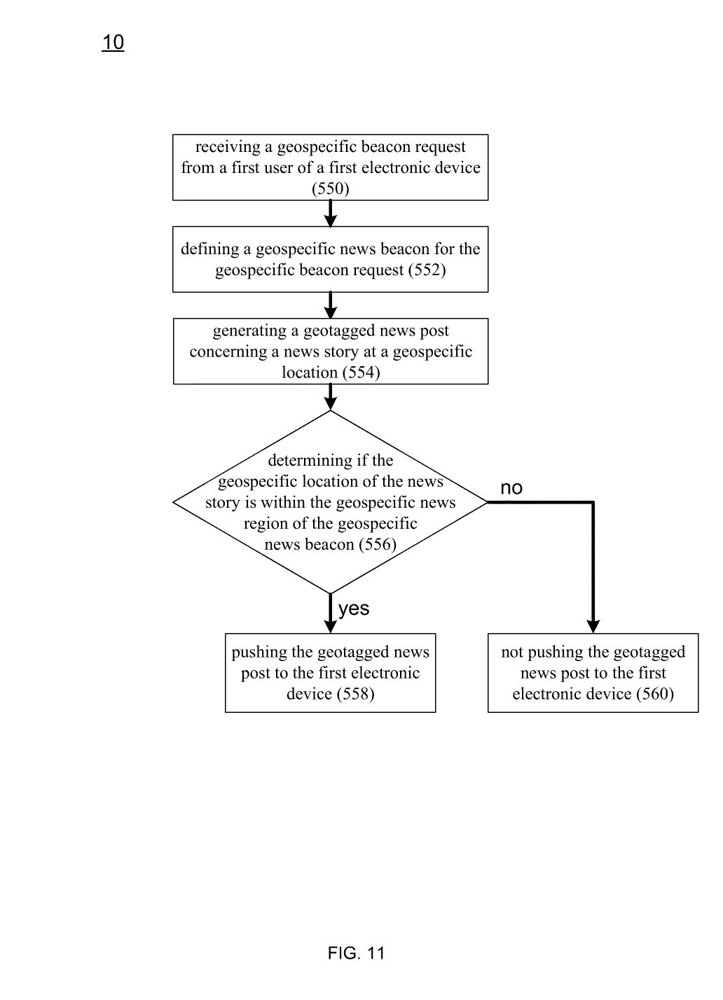

Referring also to FIG. 11, news publishing process 10 may receive 550 a geospecific beacon request (e.g., request 60) from a first user (e.g., user 42) of a first electronic device (e.g., notebook computer 34). News publishing process 10 may define 552 a geospecific news beacon (e.g., news beacon 506 for San Francisco, Calif., news beacon 508 for Des Moines, Iowa, news beacon 510 for Tampa Bay, Fla., and news beacon 512 for the “current location” of user 42) for the geospecific beacon request (e.g., request 60). Each of these geographic news beacons (e.g., news beacon 506 for San Francisco, Calif., news beacon 508 for Des Moines, Iowa, news beacon 510 for Tampa Bay, Fla., and new beacon 512 for the “current location” of user 42) may define a geospecific news region, wherein the geospecific news region may be defined via a point location (e.g., a zip code, an address, or a current location) and a radius (e.g., 5 miles), in a fashion similar to the above-described manner in which a geographic news region is defined for a geotagged news post.

Assume for illustrative purposes that news publishing process 10 generates 554 a geotagged news post (e.g., geotagged news post 250) concerning a news story (e.g., a house fire) at a geospecific location (e.g., location information 200), which in this example is Orlando, Fla. As discussed above, this geotagged news post (e.g., geotagged news post 250) may be generated based, at least in part, upon a news content item (e.g., news content item 252) provided by a second user (e.g., user 36). As discussed above, this news content item (e.g., news content item 252) may include one or more of text, photographs, videos, and audio (e.g., picture 100 and description 102), wherein the geospecific location of the news story (e.g., the house fire) may be defined based upon GPS coordinates or upon cell tower triangulation of a second electronic device (e.g., data-enabled, cellular telephone 28).

News publishing process 10 may determine 556 if the geospecific location of the news story (for this example, Orlando, Fla.) is within the geospecific news region of the geospecific news beacon. Specifically, since user 42 define four news beacons (namely news beacon 506 for San Francisco, Calif., news beacon 508 for Des Moines, Iowa, news beacon 510 for Tampa Bay, Fla., and “current location” news beacon 512), news publishing process 10 may determine 556 if the geospecific location of the news story (for this example, Orlando, Fla.) is within the geospecific news region of any of geospecific news beacons 506, 508, 510, 512.

If the geospecific location (for this example, Orlando, Fla.) of the news story (e.g., the house fire) is within the geospecific news region of the geospecific news beacon (e.g., geospecific news beacons 506, 508, 510, 512), news publishing process 10 may push 558 the geotagged news post (e.g., geotagged news post 250) to the first electronic device (e.g., notebook computer 34).

Conversely, if the geospecific location (for this example, Orlando, Fla.) of the news story (e.g., the house fire) is not within the geospecific news region of the geospecific news beacon (e.g., geospecific news beacons 506, 508, 510, 512), news publishing process 10 may not push 560 the geotagged news post (e.g., geotagged news post 250) to the first electronic device (e.g., notebook computer 34).

Since Orlando, Fla. is not within the geospecific news regions (e.g., San Francisco, Calif., Des Moines, Iowa, Tampa Bay, Fla., Long Island, N.Y. (the “current location” of user 42)) of the geospecific news beacons (e.g., geospecific news beacons 506, 508, 510, 512, respectively), news publishing process 10 will not push 560 the geotagged news post (e.g., geotagged news post 250) to the first electronic device (e.g., notebook computer 34).

User interface 106 may summarize the geotagged news posts that were pushed to the first electronic device (e.g., notebook computer 34) in e.g., the manner shown in FIG. 10D. When summarizing the geotagged news posts that were pushed to notebook computer 34, these posts may be sequenced in accordance with their individual ranking scores (in the manner described above).

As would be expected, the quantity of geotagged news posts may vary depending upon the location of a new beacon. For example, news beacon 506 for San Francisco, Calif. may generate a higher quantity of geotagged news posts than news beacon 508 for Des Moines, Iowa). Accordingly, news publishing process 10 may be configured to adjust one or more parameters to regulate news post density and ensure that the appropriate quantity of news posts are associated with the various news beacons that are defined by a user.

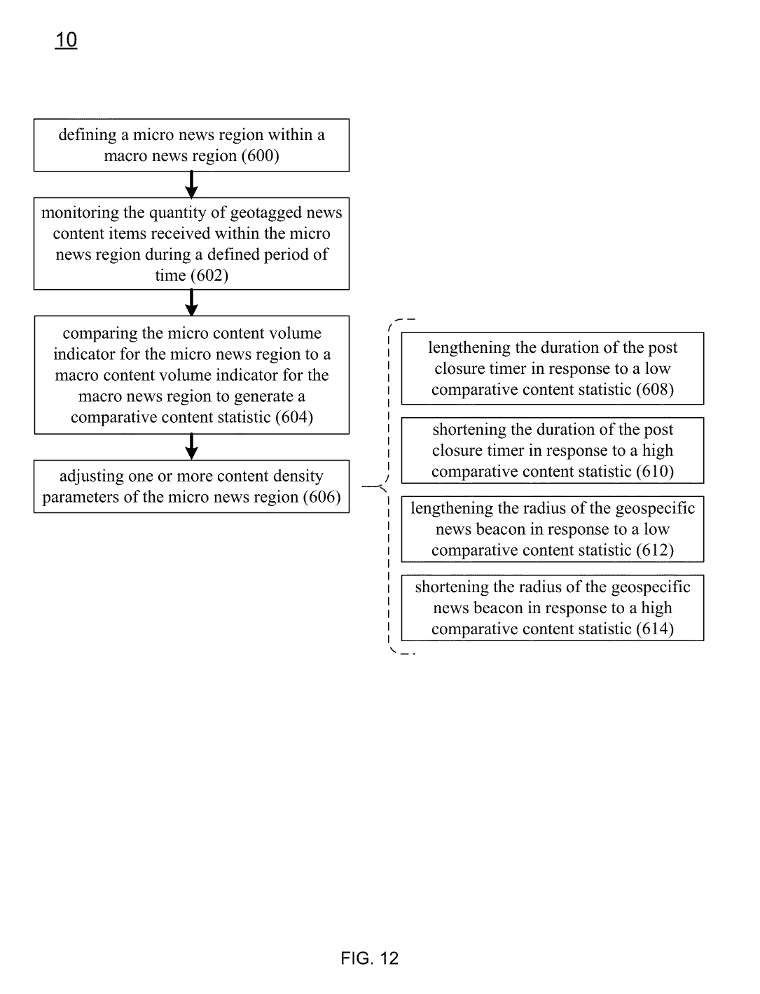

For example and referring also to FIG. 12, news publishing process 10 may define 600 a micro news region within a macro news region. An example of such a micro news region may include a region that is bounded by two lines of longitude and two lines of latitude. The area of these micro news regions may be increased or decreased to adjust the level of granularity at which new publishing process 10 may regulate the news post density. An example of such a macro news region may include a region much larger than the above-described micro news regions, examples of which may include an individual county within a state, an individual state within a country, or an entire country.

For the following example, assume that the macro news region is the entire continental United States and the micro news regions are individual two miles by two mile grids (for a total of four square miles) within the United States. Since the forty-eight contiguous states and Washington, D.C. (the macro news region) have a combined area of 3,119,884 square miles, this macro news region may be divided into 779,971 micro news regions.

News publishing process 10 may monitor 602 the quantity of geotagged news content items received within each of these micro news regions during a defined period of time (e.g., a day, a week, a month, or a year), thus defining a micro content volume indicator for each of the micro news regions. An example of such a micro content volume indicator may include (but is not limited to) geotagged news posts per day. News publishing process 10 may compare 604 this micro content volume indicator for each micro news region (which in this example is in geotagged news posts per day) to a macro content volume indicator (which would be in the same units of measurement, namely geotagged news posts per day) for the macro news region (e.g., the forty-eight contiguous states and Washington, D.C.) to generate a comparative content statistic for each micro news region.

For example, assume the macro content volume indicator for the macro news region (e.g., the forty-eight contiguous states and Washington, D.C.) is 10 geotagged news posts per day, while the micro content volume indicator is 25 geotagged news posts per day (for the micro news region within which news beacon 506 is located), 5 geotagged news posts per day (for the micro news region within which news beacon 508 is located) and 10 geotagged news posts per day (for the micro news region within which news beacon 510 is located). Accordingly, the comparative content statistic is 2.5 (i.e., 25/10) for the micro news region within which news beacon 506 is located, is 0.5 (i.e., 5/10) for the micro news region within which news beacon 508 is located, and is 1.0 (i.e., 25/10) for the micro news region within which news beacon 510 is located.

News publishing process 10 may adjust 606 one or more content density parameters of these micro news regions to alter the micro content volume indicator based, at least in part, upon these comparative content statistic.

One example of these content density parameters may include but is not limited to the duration of a post closure timer (e.g., timers 274, 276). As discussed above, expiry of the post closure timer may result in the archiving of a related geotagged news post and/or the closing of a related geotagged news post.

When adjusting 606 one or more content density parameters of the micro news region to alter the micro content volume indicator, news publishing process 10 may: lengthen 608 the duration of the post closure timer in response to a low comparative content statistic and/or shorten 610 the duration of the post closure timer in response to a high comparative content statistic.

Accordingly, news publishing process 10 may shorten 610 the duration of the post closure timer(s) for the micro news region within which news beacon 506 is located (resulting in geotagged news posts proximate news beacon 506 lasting a shorter period of time) and lengthen 608 the duration of the post closure timer for the micro news region within which news beacon 508 is located (resulting in geotagged news posts proximate news beacon 508 lasting a longer period of time).

Another example of these content density parameters may include but is not limited to the radius of a geospecific news beacon. When adjusting 606 one or more content density parameters of the micro news region to alter the micro content volume indicator, news publishing process 10 may: lengthen 612 the radius of the geospecific news beacon in response to a low comparative content statistic and/or shorten 614 the radius of the geospecific news beacon in response to a high comparative content statistic.

Accordingly, news publishing process 10 may shorten 614 the radius of the geospecific news beacon for the micro news region within which news beacon 506 is located (resulting in a decrease in the amount of geotagged news posts being proximate news beacon 506) and lengthen 612 the radius of the geospecific news beacon for the micro news region within which news beacon 508 is located (resulting in an increase in the amount of geotagged news posts being proximate news beacon 508).

As the micro news region within which news beacon 510 is located has a comparative content statistic that indicates the proper level of geotagged news posts, new publishing process 10 may not adjust any of the above-referenced content density parameters with respect to this micro news region.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
generating a geotagged news post, wherein the geotagged new post includes a plurality of discrete geotagged news content items located within a geospecific news region;
receiving feedback concerning one or more of the plurality of discrete geotagged news content items from one or more users reviewing the geotagged news post;
assigning a ranking score to each of the plurality of discrete geotagged news content items based, at least in part, upon the feedback received from the one or more users reviewing the geotagged news post; and
sequencing the plurality of discrete geotagged news content items within the geotagged news post based, at least in part, upon the ranking score assigned to each of the plurality of discrete geotagged news content items.

2. The computer-implemented method of claim 1 wherein the feedback includes an approval indicator concerning one or more of the plurality of discrete geotagged news content items.

3. The computer-implemented method of claim 1 wherein the geospecific news region is defined via a point location and a radius.

4. The computer-implemented method of claim 1 wherein the geospecific news region is defined based upon GPS coordinates of an electronic device associated with one of the plurality of discrete geotagged news content items.

5. The computer-implemented method of claim 1 wherein the geospecific news region is defined based upon cell tower triangulation of an electronic device associated with one of the plurality of discrete geotagged news content items.

6. The computer-implemented method of claim 1 further comprising:
receiving additional feedback concerning one or more of the plurality of discrete geotagged news content items.

7. The computer-implemented method of claim 6 further comprising:
updating the ranking score assigned to each of the plurality of discrete geotagged news content items based, at least in part, upon the additional feedback; and
resequencing the plurality of discrete geotagged news content items within the geotagged news post based, at least in part, upon the updated ranking score assigned to each of the plurality of discrete geotagged news content items.

8. A computer program product residing on a computer readable medium having a plurality of instructions stored thereon which, when executed by a processor, cause the processor to perform operations comprising:
generating a geotagged news post, wherein the geotagged new post includes a plurality of discrete geotagged news content items located within a geospecific news region;
receiving feedback concerning one or more of the plurality of discrete geotagged news content items from one or more users reviewing the geotagged news post;
assigning a ranking score to each of the plurality of discrete geotagged news content items based, at least in part, upon the feedback received from the one or more users reviewing the geotagged news post; and
sequencing the plurality of discrete geotagged news content items within the geotagged news post based, at least in part, upon the ranking score assigned to each of the plurality of discrete geotagged news content items.

9. The computer program product of claim 8 wherein the feedback includes an approval indicator concerning one or more of the plurality of discrete geotagged news content items.

10. The computer program product of claim 8 wherein the geospecific news region is defined via a point location and a radius.

11. The computer program product of claim 8 wherein the geospecific news region is defined based upon GPS coordinates of an electronic device associated with one of the plurality of discrete geotagged news content items.

12. The computer program product of claim 8 wherein the geospecific news region is defined based upon cell tower triangulation of an electronic device associated with one of the plurality of discrete geotagged news content items.

13. The computer program product of claim 8 further comprising:
receiving additional feedback concerning one or more of the plurality of discrete geotagged news content items.

14. The computer program product of claim 13 further comprising:
updating the ranking score assigned to each of the plurality of discrete geotagged news content items based, at least in part, upon the additional feedback; and
resequencing the plurality of discrete geotagged news content items within the geotagged news post based, at least in part, upon the updated ranking score assigned to each of the plurality of discrete geotagged news content items.

15. A computing system including a processor and memory configured to perform operations comprising:
generating a geotagged news post, wherein the geotagged new post includes a plurality of discrete geotagged news content items located within a geospecific news region;
receiving feedback concerning one or more of the plurality of discrete geotagged news content items from one or more users reviewing the geotagged news post;
assigning a ranking score to each of the plurality of discrete geotagged news content items based, at least in part, upon the feedback received from the one or more users reviewing the geotagged news post; and
sequencing the plurality of discrete geotagged news content items within the geotagged news post based, at least in part, upon the ranking score assigned to each of the plurality of discrete geotagged news content items.

16. The computing system of claim 15 wherein the feedback includes an approval indicator concerning one or more of the plurality of discrete geotagged news content items.

17. The computing system of claim 15 wherein the geospecific news region is defined via a point location and a radius.

18. The computing system of claim 15 wherein the geospecific news region is defined based upon GPS coordinates of an electronic device associated with one of the plurality of discrete geotagged news content items.

19. The computing system of claim 15 wherein the geospecific news region is defined based upon cell tower triangulation of an electronic device associated with one of the plurality of discrete geotagged news content items.

20. The computing system of claim 15 further configured to perform operations comprising:
receiving additional feedback concerning one or more of the plurality of discrete geotagged news content items.

21. The computing system of claim 20 further configured to perform operations comprising:
updating the ranking score assigned to each of the plurality of discrete geotagged news content items based, at least in part, upon the additional feedback; and
resequencing the plurality of discrete geotagged news content items within the geotagged news post based, at least in part, upon the updated ranking score assigned to each of the plurality of discrete geotagged news content items.
